(19) United States
(12) Patent Application Publication
(10) Pub. No.: US 2013/0262263 A1
(43) Pub. Date: Oct. 3, 2013

(54) COORDINATION LIST-PROVIDING SYSTEM AND RELATED METHOD

(71) Applicant: TOSHIBA TEC KABUSHIKI KAISHA, Tokyo (JP)

(72) Inventors: Keiji WATANABE, Kanagawa (JP); Ran NISHIHASHI, Tokyo (JP); Ryusuke WATANABE, Saitama (JP); Yuji HASEGAWA, Tokyo (JP)

(73) Assignee: TOSHIBA TEC KABUSHIKI KAISHA, Tokyo (JP)

(21) Appl. No.: 13/768,507

(22) Filed: Feb. 15, 2013

(30) Foreign Application Priority Data
Mar. 30, 2012 (JP) 2012-082403

(51) Int. Cl. G06Q 30/06

(52) U.S. Cl. CPC G06Q 30/0633
USPC 705/26.8

(57) ABSTRACT

According to an embodiment, coordination list-providing system is provided. The coordination list-providing system comprises a product list display unit configured to display on a display screen product information including a product image, and a product name for each of one or more products. The coordination list-providing system further comprises a detailed information display unit configured to display on the display screen detailed information of a selected product that is selected from the one or more products. The coordination list-providing system further comprises a coordination list unit configured to provide a coordination list comprising one or more coordination images of coordinating products associated with the selected product when a predetermined operation is performed.

### CROSS-REFERENCE TO RELATED APPLICATION

This application is based upon and claims the benefit of priority from Japanese Patent Application No, 2012-082403, filed Mar. 30, 2012; the entire contents of which are incorporated herein by reference.

### FIELD

Embodiments described herein relate with a coordination list-providing system and a method related thereto.

### BACKGROUND

Conventionally, when purchasing a product, such as clothing, a store clerk would show a customer many different kinds of products on that spot. In some cases, a customer might refer to a coordination example, displayed in the store. In recent years, purchasing a product has been supported by computer processing by displaying a combination of different products.

However, when a store clerk combines many different products to create a coordination example on the spot and shows it to a customer, it is a very complicated task for the customer to make a comparison and consideration. Moreover, when referring to a coordination example currently displayed in the store, or the combination of different products displayed on a computer, those examples can only he seen temporarily, i.e., in the store. Such coordination examples cannot he referred to again after purchase. Also, the coordination information the customer needs to refer to is a coordination example for one article chosen or purchased by the customer, not the coordination examples by the optional combinations shown in the store.

### DESCRIPTION OF THE DRAWINGS

FIG. 1 is a block diagram showing a configuration of a coordination list-providing system according to one embodiment.

FIG. 2 is a block diagram showing a hardware configuration of a tablet PC according to the embodiment.

FIG. 3 is a functional block diagram showing features of the tablet PC according to the embodiment.

FIG. 4 is a block diagram showing the a hardware configuration of a server according to the embodiment.

FIG. 5 is a functional block diagram showing features of the server according to the embodiment.

FIG, 6 is a figure showing an example of a product master database.

FIG. 7A is a figure showing an example of a coordination database.

FIG. 7B is a figure showing another example of a coordination database.

FIG. 8 is a figure showing an example of a customer master database.

FIG. 9 is a figure showing an example of a display screen on the tablet PC according to the embodiment.

FIG. 10 is a figure showing an example of another display screen on the tablet PC according to the embodiment.

FIG. 11 is a figure showing an example of another display screen on the tablet PC according to the embodiment.

FIG. 12 is a sequence of operations for the tablet PC and the server according to the embodiment.

FIG. 13 is another sequence of operations for the tablet PC and the server according to the embodiment.

FIG. 14 is another sequence of operations for the tablet PC and the server according to the embodiment.

FIG. 15 is another sequence of operations for the tablet PC and the server according to the embodiment.

### DETAILED DESCRIPTION

According to an embodiment of the present application, a coordination list-providing system is provided. The coordination list-providing system comprises a product list display unit configured to display on a display screen product information including a product image, and a product name for each of one or more products. The coordination list-providing system further comprises a detailed information display unit configured to display on the display screen detailed information of a selected product that is selected from the one or more products. The coordination list-providing system further comprises a coordination list unit configured to provide a coordination list comprising one or more coordination images of coordinating products associated with the selected product when a predetermined operation is performed.

According to another embodiment, a method for providing a coordination list is provided. The method comprises providing, for display, product information comprising a product image, and a product name for each of one or more products. The method further comprises providing, for display, detailed information of a selected product that is selected from the one or more products. The method further comprises providing, when a predetermined operation is performed, a coordination list comprising one or more coordination images of coordinating products associated with the selected product.

According to another embodiment, a coordination list-providing system is provided. The coordination list-providing system comprises a storage device configured store a database, the database including available product information for a plurality of available products, wherein the available product information comprises, for each of the available products: product information including a product image, and a product name for the available product, detailed product information, and a coordination list including coordinating images of coordinating products associated with the available product. The coordination list-providing system further comprises a product information unit configured to extract the product information for one or more of the available products from the data and provide the extracted product information for display. The coordination list-providing system further comprises a detailed product information unit configured so extract the detailed product information of a selected product and provide the extracted detailed product information for display, and a coordination list unit configured to extract the coordination list and provide the coordination list when a predetermined operation is performed.

FIG. 1 is a block diagram showing the configuration of the coordination list-providing system according to one embodiment. The coordination list-providing system shown in FIG. 1 includes a tablet PC 10, a server 20, a POS terminal 30, and a printer 40. The tablet PC 10 and the server 20 are connected by a wireless LAN, such as Wi-Fi, for example, and the server 20, POS terminal 30, and printer 40 are connected by a cable LAN or wireless LAN. In addition, the server 20 can also be connected with a network 50, such as the Internet. In addition, since the POS terminal 30 and the printer 40 are the same as that of the conventional ones, the explanation thereof will be omitted here.

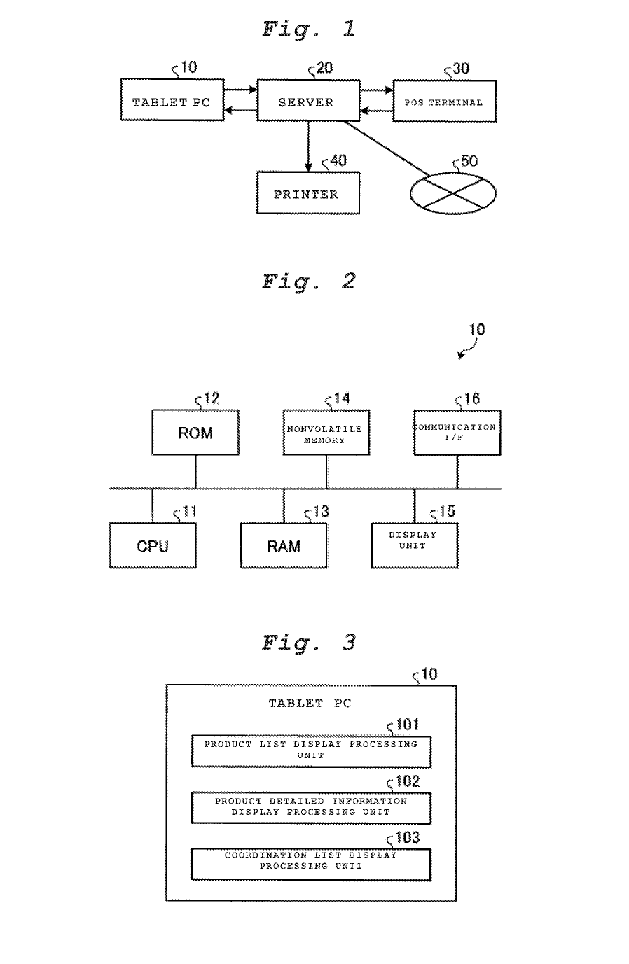

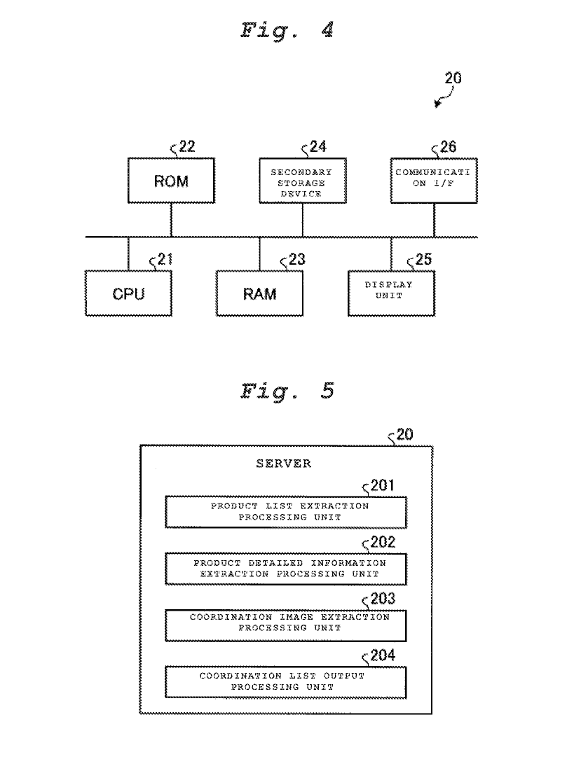

FIG. 2 is a block diagram showing the fundamental hardware configuration of the tablet PC 10. As shown in FIG. 2, the tablet PC 10 is configured to include a CPU (Central Processing Unit) 11, ROM (Read Only Memory) 12, RAM (Random Access Memory) 13, nonvolatile memory 14, display unit 15, and communication interface (I/F) 16.

CPU 11 controls the tablet PC 10 by loading to RAM 13 a predetermined control program (including the program for displaying a product list, product detailed information, a coordination list, etc.) stored in the ROM 12 or the non-volatile memory 14 and executing the program. Initial programs and various data are stored in the ROM 12.

The RAM 13 is volatile semiconductor memory used as the main memory and the work memory that holds various data temporarily when running various programs. The nonvolatile memory 14 is a nonvolatile semiconductor memory that stores various programs (the above-mentioned control program, etc.) and data.

The display unit 15 is means to display various kinds of images generated in the tablet PC 10. The display unit 15 may be, for example, a liquid crystal panel, and is equipped with a touch panel as an input means on the screen. Although the communication I/F 16 is an interface device for carrying out a communication between the server 20 and connected to the server 20 by a wireless LAN, it is not limited thereto.

The functional block diagram showing features of the tablet PC 10 in this embodiment is shown in FIG. 3.

The tablet PC 10 is equipped with a product list display processing unit 101 that displays a product list on the display unit 15, a product detailed information display processing unit 102 that displays product detailed information on the display unit, and the coordination list display processing unit 103 that displays a coordination list on the display unit as shown in FIG, 3. The operation of each processing unit will be explained in the explanation of the display screen, which will be mentioned later, along with the explanation of the operation of the server 20. Each processing unit is controlled by the execution of the above-mentioned control program by the CPU 11.

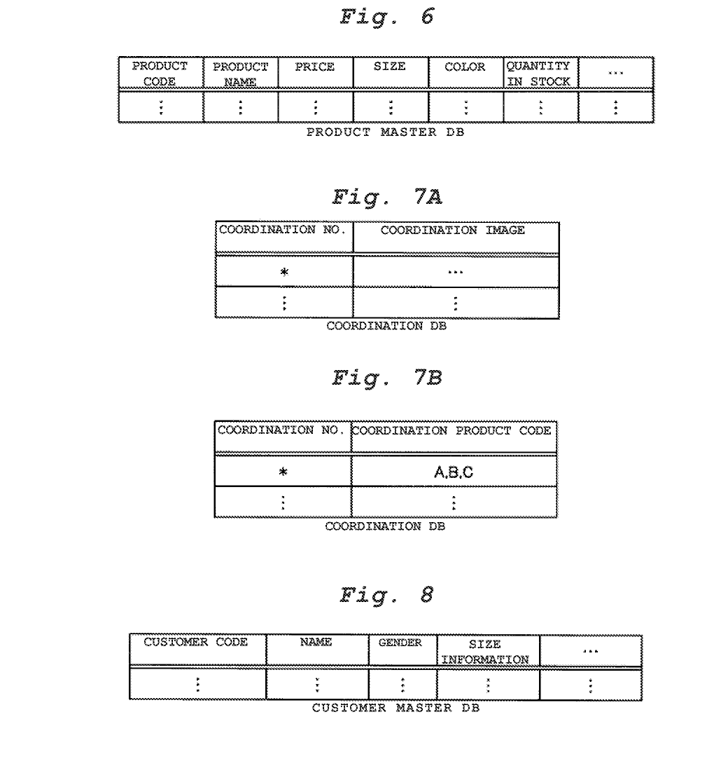

FIG. 4 is a block diagram showing the hardware configuration of the server 20. As shown in FIG. 4, the server 20 includes a CPU 21, ROM 22, PAM 23, secondary storage device 24, display unit 25, and communication I/F 26.

The CPU 21 controls the server 20 by loading to RAM 13 and executing a predetermined control program stored in the ROM 22 or the secondary storage device 24. The control program may be, for example, a Database Management System (DBMS), a program for printing the coordination list by a printer 40 following an accounting process, or a program for sending emails. Initial programs and various data are memorized in the ROM 22.

The RAM 23 is a volatile semiconductor memory that holds various data temporarily when running various programs. The secondary storage device 24 is a nonvolatile memory storage that stores various programs (including the above-mentioned control program, etc.) and data. The secondary storage device may be a Hard Disk Drive (HDD) or the like. This secondary storage device 24 stores the data of the product master DB, and the coordination DB, both of which will be mentioned later.

The display unit 25 is configured to display various kinds of images generated by the server 20. The display unit may be, for example, a liquid crystal panel or the like. The communication I/F 26 is an interface device for carrying out communication between the POS terminal 30 and the networks 50, such as the Internet.

The functional block diagram showing features of the server 20 in this embodiment is shown in FIG. 5.

As shown in FIG. 5, the server 20 is equipped with: a product list extraction processing unit 201 for extracting a product list from the product master DB (which will be mentioned later), a product detailed information extraction processing unit 202 for extracting the product detailed information from the product master DB, a coordination image extraction processing unit 203 for extracting the image data for a coordination list from the coordination DB, and a coordination list output processing unit 204 for outputting the coordination list. The coordination list output processing unit outputs the coordination list to the printer 40, or as an E-mail through the network 50. In addition, each processing unit is controlled by executing the above-mentioned control program by the CPU 21.

An example of the product master DB is shown in FIG. 6. The product master DB is a database that has the following data for each of the available products in a physical store or in the online (EC) store: product code, product name, price, size, color, stock quantity, material, place of production, brand name, category, magazine in which the product has been listed, product details, product image(s), color development image, point information, etc. for every product.

An example of the coordination DB is shown in FIG. 7A and FIG. 7B. The coordination DB is a database that includes: a coordination image, a coordination product code, and product codes of two or more products that are coordinating products. The coordination number is used as the main key.

An example of a customer master DB is shown in FIG. 8. The customer master DB is a database that includes, for each customer: a customer code, customer's name, gender, size information, points that can be used for purchase, mailing address, and other useful customer information.

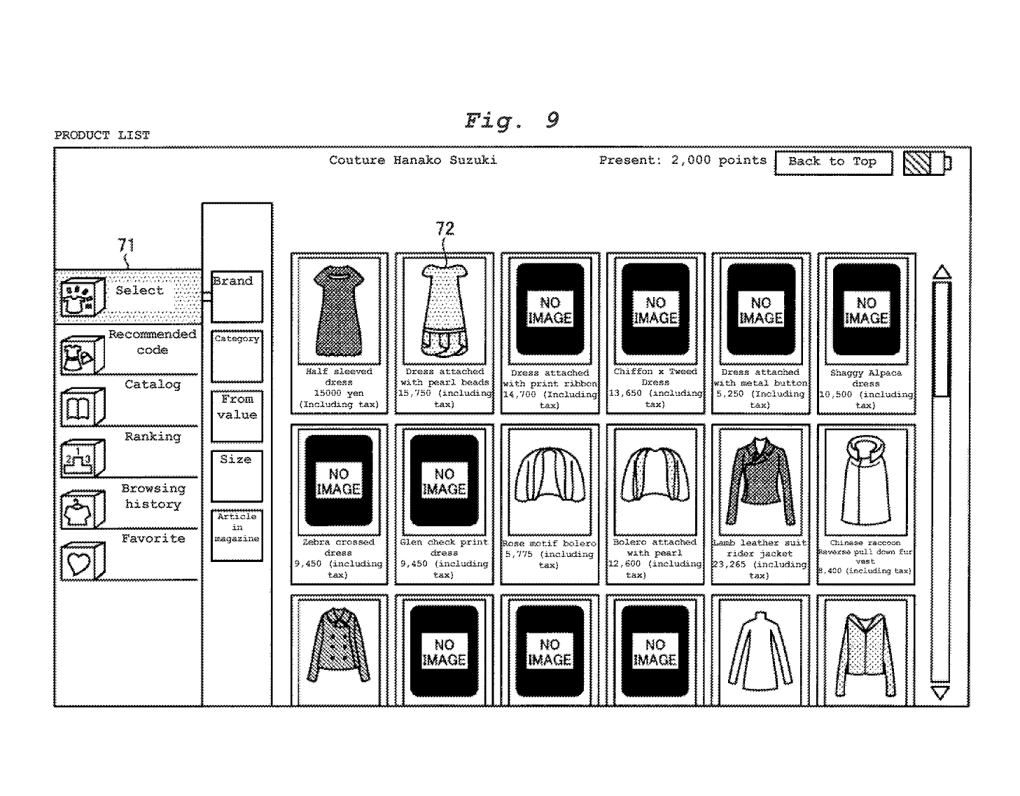

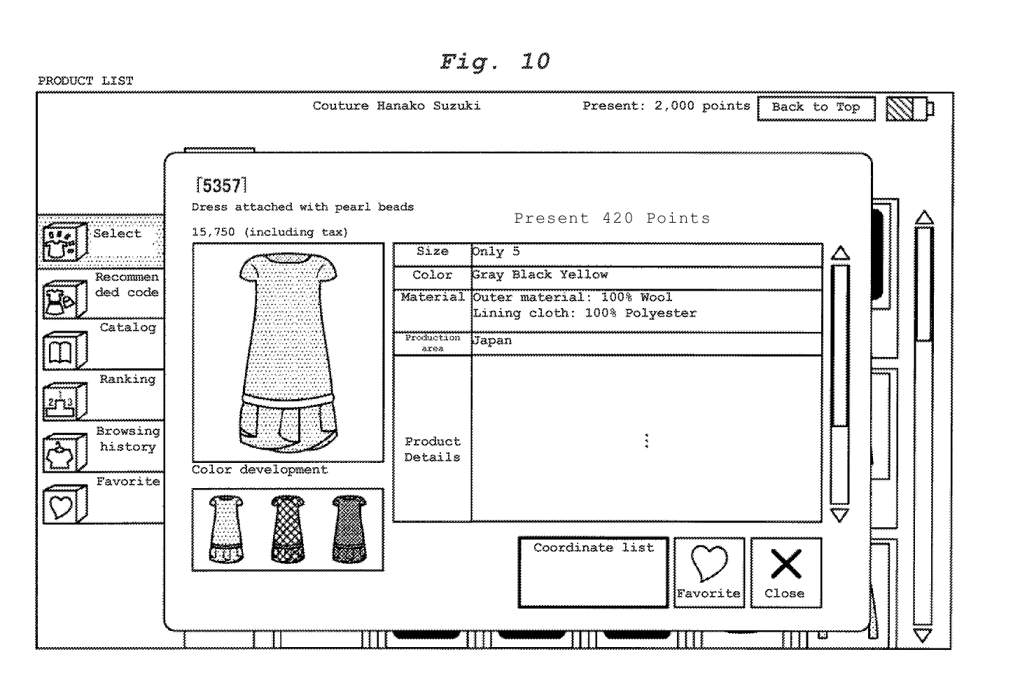

FIGS. 9-11 show examples of certain display screens on the tablet PC 10 in this embodiment.

FIG. 9 shows a product list which allows a customer to choose a selected product from among several product displayed on the display screen of the tablet PC 10.

The operation of the system (i.e., the tablet PC 10 and the server 20) during this display is shown in FIG. 12. When a customer touches the “Select” button indicated by the number 71 on the tablet PC 10 (Step S101), a product information request will be transmitted to the server 20 by the product list display processing unit 101 from the tablet PC 10 (Step S102).

In response to this request, the product list extraction processing unit 201 (on server 20) extracts the data for the product list based on the information in the product master DB stored in the secondary storage device 21 (Step S103). The product list data is transmitted to the tablet PC 10 (Step S104).

In the tablet PC 10, the product list (i.e., the product images, product names, and price information of several products) is displayed side by side on the display unit 25 as a product, list by the product list display processing unit 101 based on the product list data returned from the server 20 (Step S105). The display is divided into areas for each product associated with each product code. The product list is displayed in this manner by the tablet PC 10.

In addition, although the example shown in the same drawing displays a product list by each brand, it can also display a product list by each category (a coat, skirt, jacket, etc.), by price, by size, and by magazine in which the product is listed. In addition, the example shown in FIG. 9 shows the customer's name and the points (associated with the customer code) that can be used by the customer, wherein the customer data has been registered in advance. Thus, the information displayed is specific to the customer that uses the tablet PC 10.

In the example shown in FIG. 9, when a customer chooses the display portion of the dress with pearl beads indicated by the number 72 through the touch panel on the tablet PC 10, the screen that displays the details of the product will be displayed as a pop-up view on the product list. The example of such screen is shown in FIG. 10.

The operation of the system (i.e., the tablet PC 10 and she server 20) at this time is shown in FIG. 13. When a customer selects the dress with pearl beads as indicated by the number 72 through the touch panel on the tablet PC 10 (Step S201) the product detailed information request containing the product code associated with the area indicated by this number 72 will be transmitted to the server 20 (Step S202). In response to this request, the product detailed information extraction processing unit 202 (on server 20) extracts the detailed information for the selected product from the product master DB stored in the secondary storage device 24 (Step S203) The detailed information for the selected product is sent to the tablet PC 10 (Step S204) The tablet PC 10 displays the detailed information for the selected product as a pop-up display as shown in FIG. 10 based on the detailed information returned from the server 20 (Step S205).

In the display example of FIG. 10, the detailed information of the selected product (including the product code, product name, price, product image, color development image, and point information) are displayed. Moreover, on this pop-up screen, buttons representing “A coordination list”, “Favorite”, and “Close” are also displayed.

The customer can register the selected product as his/her favorite by touching “Favorite” button. The product information registered will be associated with the customer data of that particular customer, and saved in the customer master DB in the secondary storage device 24 of the server 20, Also, the customer can close the pop-up display of FIG. 10 by clicking the “Close” button.

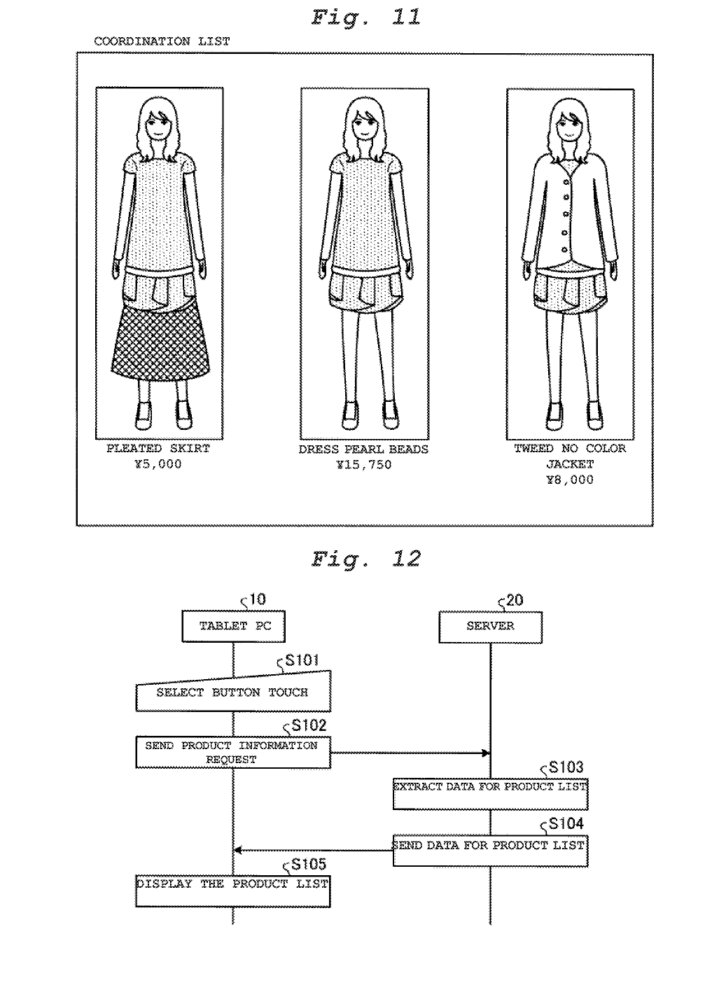

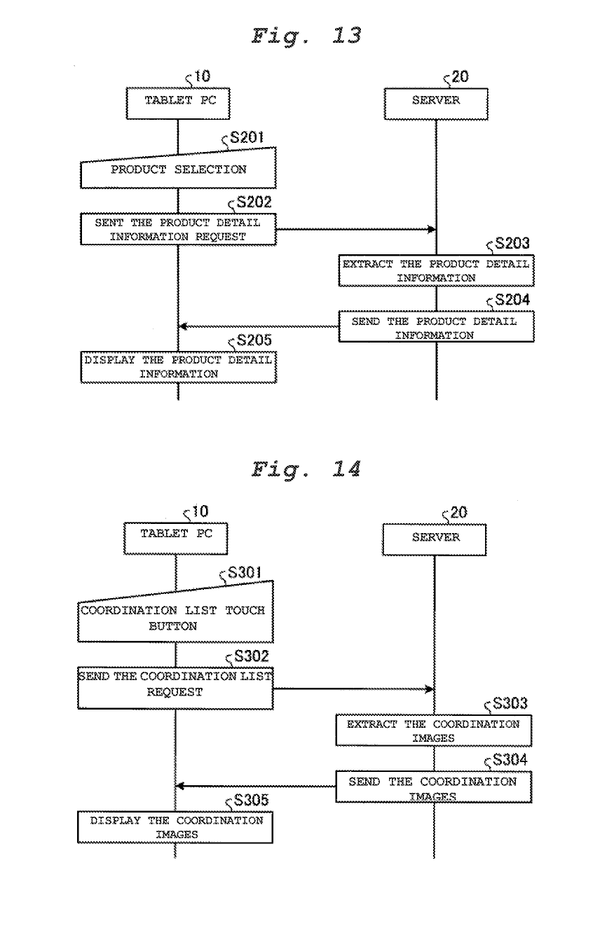

When the customer touches the “Coordination list” button, the coordination list as shown in FIG. 11 will be displayed. The operation of the system (i.e., the tablet PC 10 and the server 20) at that time will be as shown in FIG. 14. When the customer touches the “Coordination list” button (Step S301), the coordination list request that contains the product code of the selected product will be transmitted from the tablet PC 10 to the server 20 (Step S302). In response so this request, the coordination image extraction processing unit 203 (on server 20) searches the coordination DB for the coordination number that matches with the product code of the selected product and extracts the coordination images corresponding to the selected product (Step S303). Next, the coordination images of the coordination number that matched is sent to the tablet. PC 10 (Step S304). It this time, the server 20 associates the extracted coordination images with the customer code and the product code.

The tablet PC 10 displays the coordination images returned from the server 20 as a coordination list (Step S305). In FIG. 11, the coordination images are horizontally displayed in a row as an example of a coordination list, although it is not limited thereto. In addition, the coordination images displayed on a coordination list may be used for coordination of other products, with respect to the product (one article) selected by the customer. That is, other products that match the product (one article) selected by the customer may be proposed to the customer.

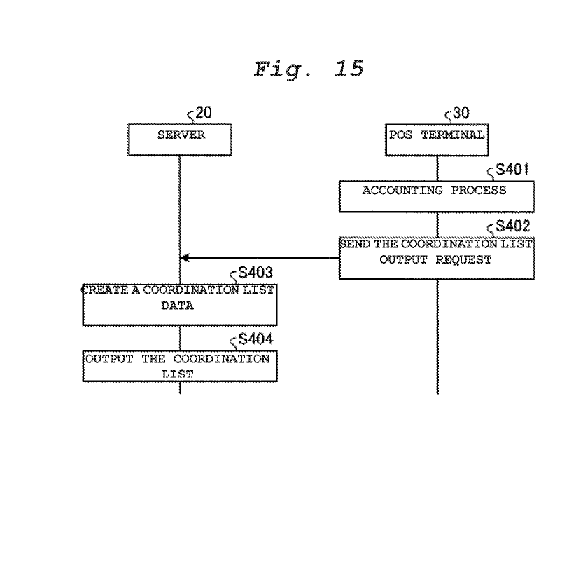

Next, the operation of the coordination list-providing system when a customer purchases a product (at the time of accounting) will be as follows (refer to FIG. 15).

In POS terminal 30, when a predetermined accounting process with respect to a selected product is carried out (i.e., purchase of the product, Step S401) , a coordination list output request containing a customer code and product code will be transmitted to the server 20 from the PGS terminal 30 (Step S402). The customer code can be specified from a point card, or the like, that the customer has. Moreover, the product code can be specified from the bar code attached to the product,

The server 20 that received the coordination list output request from the POS terminal 30 uses the coordination images associated with the customer code and product code that are held during the process in Step S304 mentioned previously and arranges the data of the coordination list in a predetermined template (Step S4030). The coordination list is then output (Step S404). As one example of outputting the coordination list, a printing instruction is output from the server 20 to the printer 40. During printing, the product names and prices other than the purchased product will be printed, along with the link, address (for example, based on the QR (registered trademark) code, URL, etc.) to a website. The customer is provided with the printed coordination list to which the customer can refer later. Moreover, it also becomes possible to view the coordination list containing the products that can be purchased at that point and to obtain further information by accessing to the website using the above-mentioned link address.

As another example of outputting the coordination list, the server 20 can send the above-mentioned coordination list as an email, to the email address specified by the customer from the customer master DB based on the customer code in addition to the printout, or in replacement of the printout of the coordination list. In addition, during the output of the coordination list (including the time when the customer accessed a predetermined website), the color and size (those applicable to the customer's size information) as well as the season or stock of the products that have been included in the coordination with she product purchased will also be taken into consideration. For example, products that are out of season or out of stock may be excluded from the coordination list. Moreover, information for the products that have few inventories left or are out of stock but can be ordered may also be presented.

As has been explained above, according to the coordination list-providing system of this embodiment, the system provides the information about coordinating products such as clothing, etc that a customer truly needs. That is, since the system provides the coordination list associated with the product that the customer has selected for the purpose of purchase, the system can support the customer after product purchase and provide an effective sales promotion to the store.

In addition, the control program run by the tablet PC 10 and the server 20 of this embodiment is provided by storing the program in a medium readable by a computer, such as CD-ROMs, flexible disks (FD), CD-Rs, DVDs (Digital Versatile Disk) etc. in a file format that can be installed in and run by a computer. Furthermore, the above-mentioned control program may be configured so that it can be provided by download via a network and stored in a computer connected to a network, such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is

1. A coordination list-providing system comprising:
a product list display unit configured to display on a display screen product information including a product image, and a product name for each of one or more products,
a detailed information display unit configured to display on the display screen detailed information of a selected product that is selected from the one or more products, and
a coordination list unit configured to provide a coordination list comprising one or more coordination images of coordinating products associated with the selected product when a predetermined operation is performed.

2. The coordination list-providing system according to claim 1, further comprising:
a server configured to store a database, the database including available product information for a plurality of available products including the one or more products, wherein the available product information comprises, for each of the available products:
the product information,
the detailed product information, and
the coordination list, wherein
the product list display unit receives the product information from the server,
the detailed information display unit receives the detailed information from the server,
and the coordination list unit receives the coordination list from the server.

3. The coordination list-providing system according to claim 1, wherein:
the predetermined operation comprises an accounting process in which purchase of at least the selected product is finalized, and
the server comprises a coordination list output unit configured to output the coordination list as one of a printout and an email.

4. The coordination list-providing system according to claim 3, further comprising a POS terminal connected to the server, the PCI terminal configured to perform the accounting process.

5. The coordination list-providing system according to claim 3, wherein the coordination list further comprises the product information for the coordinating products

6. The coordination list-providing system according to claim 5, wherein the coordination list comprises an internet address to a website that includes the one or more coordination images of coordinating products.

7. The coordination list-providing system according to claim 3, wherein the coordination list includes a stock status of the coordinating items.

8. The coordination list-providing system according to claim 3, wherein the coordination list does not include a coordination image of a coordinating product if the coordinating product is out of stock.

9. A method for providing a coordination list comprising:
providing, for display, product information comprising a product image, and a product name for each of one or more products;
providing, for display, detailed information of a selected product that is selected from the one or more products; and
providing, when a predetermined operation is performed, a coordination list comprising one or more coordination images of coordinating products associated with the selected product.

10. The method for providing a coordination list according to claim 9, further comprising:
performing an accounting process as the predetermined operation, wherein the accounting process comprises finalizing a purchase of at least the selected product.

11. The method for providing a coordination list according to claim 10, wherein the coordination list is provided as one of a printout and an email.

12. The method for providing a coordination list according to claim 10, wherein the accounting process is performed at a PCI terminal.

13. The method for providing a coordination list according to claim 10, wherein the coordination list further comprises the product information for the coordinating products.

14. The method for providing a coordination list according to claim 10, wherein the coordination list comprises an internet address to a website that includes the one or more coordination images of coordinating products.

15. The method for providing a coordination list according to claim 10, wherein the coordination list includes a stock status of the coordinating items.

16. The method for providing a coordination list according to claim 10, wherein the coordination list does not include coordination image of a coordinating product if the coordinating product is out of stock.

17. A coordination list-providing system comprising:
a storage device configured store a database, the database including available product information for a plurality of available products, wherein the available product information comprises, for each of the available products
product information including a product image, and a product name for the available product,
detailed product information, and
a coordination list including coordinating images of coordinating products associated with the available product;
a product information unit configured to extract the product information for one or more of the available products from the data and provide the extracted product information for display;
a detailed product information unit configured to extract the detailed product information of a selected product and provide the extracted detailed product information for display; and
a coordination list unit configured to extract the coordination list and provide the coordination list, when a predetermined operation is performed.

18. The coordination list-providing system according to claim 17, further comprising:
a communication interface configured to receive the extracted product information and the extracted detailed product information; and
a display unit configured to display the received extracted product information and the received extracted detailed product information.

19. The coordination list-providing system according to claim 17, wherein the predetermined operation comprises an accounting process in which purchase of at least the selected product is finalized.

20. The coordination list-providing system according to claim 19, wherein the coordination list unit is provided as one of a printout and an email.
